(19) United States
(12) Patent Application Publication
(10) Pub. No.: US 2009/0103203 A1
(43) Pub. Date: Apr. 23, 2009

(54) RECORDING APPARATUS AND CONTROL CIRCUIT

(75) Inventor: Osamu Yoshida, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/208,041

(22) Filed: Sep. 10, 2008

(30) Foreign Application Priority Data
Oct. 22, 2007 (JP) 2007-273674

(51) Int. Cl. G11B 21/02; G11B 5/127

(52) U.S. Cl. 360/75; 360/110; G9B/21.003; G9B/5.04

(57) ABSTRACT

It relates to a hybrid recording apparatus using. The recording apparatus includes a magnetic disk medium for recording and reading data by a magnetic head, a nonvolatile memory in which a write cache area is allocated, a cache control unit for temporarily loading write data, which is recorded on the magnetic disk medium, into the write cache area in accordance with a write request from a higher-level apparatus. A memory allocation management unit stores memory management information in the magnetic disk medium for management thereof, the memory management information representing an allocated position of the write cache area in the nonvolatile memory.

### BACKGROUND OF THE INVENTION

1. Field of the Invention

The present invention relates to a hybrid recording apparatus using, as recording media, a disk medium and a nonvolatile memory, and to a control circuit. More particularly, the present invention relates to a recording apparatus using, as a cache area, a nonvolatile memory having a limitation in the number of times of rewrites, e.g., a flash memory, and to a control circuit for the recording apparatus.

2. Description of the Related Art

Hitherto, a magnetic disk apparatus employs, as a recording medium, a magnetic disk onto and from which data is recorded and read using a magnetic head. Also, a hybrid magnetic disk apparatus has been recently developed which is a combination of a magnetic disk (medium) and a flash memory serving as a nonvolatile memory.

The hybrid magnetic disk apparatus has a write cache. When write data received in response to a write command from a host, for example, is temporarily stored in the flash memory and more write data cannot be held in the flash memory, the data is written onto the magnetic disk.

Also, the hybrid magnetic disk apparatus has a read cache function. Upon receiving a read command from the host, if the target data is present in the flash memory, the target data is read out from the flash memory and is transferred to the host.

During a period in which data is written into and read out from the flash memory as described above, a spindle motor for rotating the magnetic disk can be kept stopped. Therefore, power consumed by the magnetic disk apparatus can be reduced. The reduction of power consumption is effective primarily in a mobile personal computer.

On the other hand, the flash memory used as a nonvolatile memory in the hybrid magnetic disk apparatus has a limitation in the number of times of rewrites and erasures because deterioration of the memory device progresses with each rewrite operation. At present, rewrites up to about hundred thousand times are regarded as allowable.

In the above-described situation, the frequency of use per cell of the flash memory can be reduced by using each flash memory cell the same number of times. As a result, the rewrite life of the flash memory is expected to be eventually prolonged several tens of times or more.

The above-described technique is generally called wear leveling. Stated another way, in an apparatus employing a nonvolatile memory which has a limitation in the number of times of rewrites, e.g., a flash memory, an improvement is proposed so that write accesses are evenly performed across the flash memory cells without causing excessive accesses to a particular memory area.

In a memory disk apparatus called a Solid State Drive (SSD), for example, which employs only a nonvolatile memory as a recording medium without using a disk medium, the wear leveling technique for the allocation of data in the nonvolatile memory to evenly use the nonvolatile memory is practiced by dividing a flash memory into sectors of 16 Kbytes, 32 Kbytes, or 64 Kbytes per erase size and employing those sectors which have the minimum frequency of uses. In addition, memory management information indicating assignment of data areas of the nonvolatile memory is also required to be placed in the nonvolatile memory. Thus, the flash memory has to be evenly used, taking into account the number of updates of the memory management information as well.

However, it is difficult to change the position of the memory management information. This is because, if the memory management information indicating the allocation of information within the nonvolatile memory is itself moved, the information under management cannot be obtained.

For that reason, various methods have been proposed regarding how to hold the memory management information. According to one method, for example, multiple areas are prepared for the memory management information, and the area to be used is changed from one to another when the number of uses reaches a certain level. That method enables the location of the memory management information to be confirmed at all times.

The wear leveling technique can also be used in the hybrid magnetic disk apparatus. In the magnetic disk apparatus, however, because a mechanical operation, such as a seeking operation of a magnetic head, is performed, it is said that the rewrite life of the flash memory and the life of the magnetic disk apparatus are comparable to each other. Therefore, the wear leveling is not regarded to be so important at present.

Meanwhile, the life of the magnetic disk apparatus tends to increase year by year. If the life of the magnetic disk apparatus exceeds the rewrite life of the flash memory in the future, the life of the hybrid magnetic disk apparatus will be restricted by the rewrite life of the flash memory, and the wear leveling method will also become important for the flash memory in the hybrid magnetic disk apparatus.

However, the following problem arises when the wear leveling technique is applied to the flash memory included in the known hybrid magnetic disk apparatus.

When the flash memory is practiced by placing a cache area in a nonvolatile memory, cache data is generally stored in the cache area that is divided per certain size. For example, write data received from a host is loaded into one of several cache areas which are divided per 32 sectors or 16 sectors and are each called a page.

Such a division into pages is intended to reduce the temporal overhead of a CPU in handling the cache data. In other words, looking at an algorithm used for handling the cache data, the algorithm can be prepared in a relatively simple configuration by handling the cache data while the cache area is divided per certain size. Hence, an improvement of performance in a response to the host is expected corresponding to a reduction of overhead in the algorithm processing time.

From the viewpoint of averaging the number of times of uses of the flash memory, however, handling the cache data per divided page creates a location where the number of times of uses cannot be averaged within the page.

Assuming, for example, that the page size of the cache area is 16 sectors and write data issued in response to a write command has a size of about 1 sector. If the write data having such a size is issued successively, only an area corresponding to one sector is used which is located at the head of one divided page in the cache area. This means that areas corresponding to the remaining 15 sectors are not used.

Thus, when the flash memory is used as the cache area, a large difference in frequency of rewrites occurs within the cache page between one location where rewrites are frequently generated and another location where rewrites are not so frequently generated.

Variations of the rewrite frequency in the cache area cannot be overcome by the known wear leveling technique. More specifically, with the known wear leveling technique, the address assigned to be used is cyclically shifted in units of erase size (per erase unit) of the flash memory, e.g., per erase unit of 16 Kbytes which corresponds to the page size of 16 sectors (1 sector=1024 bytes).

When the wear leveling technique is performed in such a manner, the page size for the cache data and the shift size for wear leveling are synchronized with each other and, in each page used as the cache area, sectors which are located in rearward areas of the page and which are not used still remain located in the rearward areas even after the cyclic shift of the cache area.

As described above, the technique of cyclically shifting the cache area per erase size of the flash memory is basically not useful for averaging the frequency of rewrites within the cache page between one location frequently used and another location not so frequently used.

An object of the present invention is to provide a recording apparatus capable of increasing the number of possible rewrites in a nonvolatile memory, which is used as a cache area, by utilizing the feature of a disk medium, and to provide a control circuit for the recording apparatus.

### SUMMARY

In accordance with an aspect of an embodiment, a recording apparatus includes a magnetic disk medium for recording and reading data by a magnetic head, a nonvolatile memory in which a write cache area is allocated, a cache control unit for temporarily loading write data, which is recorded on the magnetic disk medium, into the write cache area in accordance with a write request from a higher-level apparatus. A memory allocation management unit stores memory management information in the magnetic disk medium for management thereof, the memory management information representing an allocated position of the write cache area in the nonvolatile memory. A memory allocation changing unit changes the memory management information to cyclically shift the write cache area in units of a predetermined address size that is smaller than an erase unit of the nonvolatile memory, whenever write cache data in the write cache area allocated in the nonvolatile memory is all written onto the magnetic disk medium and the write cache area is emptied.

### BRIEF DESCRIPTION OF THE DRAWINGS

FIG. 1 is a block diagram of a hybrid magnetic disk apparatus as a recording apparatus according to an embodiment of the present invention;

FIG. 2 is an explanatory view illustrating memory management information in FIG. 1;

FIGS. 3A and 3B are explanatory views illustrating page division of the write cache area in the embodiment and a wear leveling process per erase unit of the nonvolatile memory, respectively;

FIGS. 4A to 4C are explanatory views illustrating page division of the write cache area and wear leveling per one sector size according to the embodiment;

FIGS. 5A and 5B are explanatory views illustrating a data write process per erase unit in a nonvolatile memory according to the embodiment;

FIGS. 6A to 6D are explanatory views illustrating a rewrite process for the nonvolatile memory, which is executed in units of one sector size according to the embodiment;

FIG. 7 is a flowchart illustrating a control process, including the wear leveling, according to the embodiment;

FIG. 8 is a flowchart illustrating, continued from FIG. 7, the control process according to the embodiment;

FIG. 9 is a flowchart illustrating details of write cache wear leveling in step S18 of FIG. 8;

FIG. 10 is a flowchart illustrating details of read cache wear leveling in step S20 of FIG. 8; and

FIG. 11 is a flowchart illustrating details of the wear leveling process at idle in step S23 of FIG. 7.

### DESCRIPTION OF THE PREFERRED EMBODIMENTS

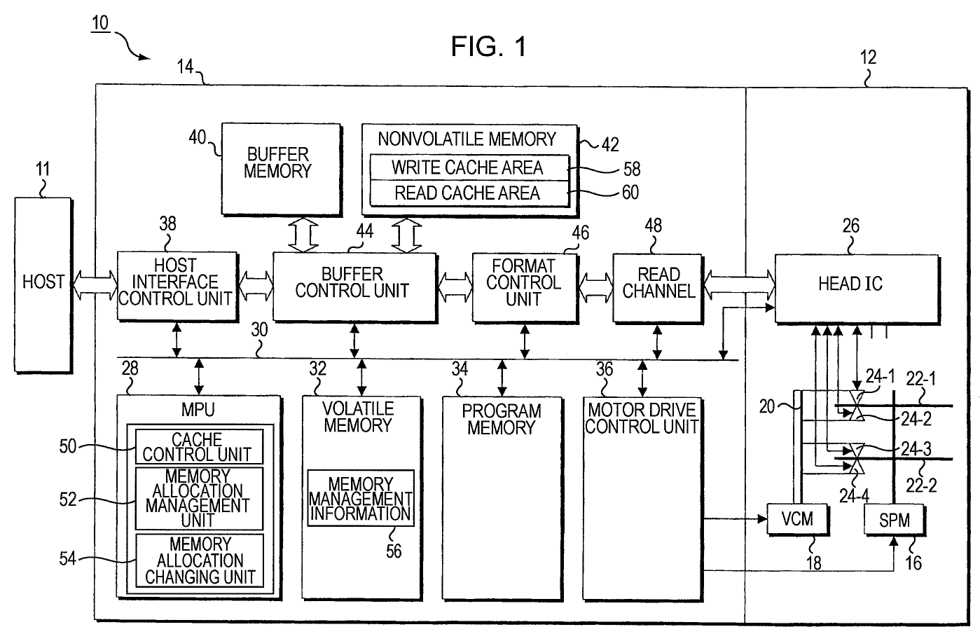

FIG. 1 is a block diagram of a hybrid magnetic disk apparatus as a recording apparatus, which includes a nonvolatile memory in addition to a magnetic disk, according to an embodiment of the present invention.

Referring to FIG. 1, a magnetic disk apparatus 10, known as a hard disk drive (HDD), comprises a disk enclosure 12 and a control board 14. A spindle motor (SPM) 16 is disposed in the disk enclosure 12, and magnetic disks 22-1 and 22-2 are mounted on a rotary shaft of the spindle motor 16 and rotated at a constant speed of, e.g., 4200 rpm.

A voice coil motor (VCM) 18 is disposed in the disk enclosure 12 to drive a rotary actuator 20 which is provided with magnetic heads 24-1 to 24-4 at its distal end, thus positioning the magnetic heads with respect to respective recording surfaces of the magnetic disks 22-1 and 22-2.

The magnetic heads 24-1 to 24-4 are each a composite head including a recording head element and a read head element which are integrated with each other. The recording head element is made of a recording head element of the longitudinal magnetic recording type or a recording head element of the perpendicular magnetic recording type. When the recording head element of the perpendicular magnetic recording type is employed, the magnetic disks 22-1 and 22-2 are each made of a perpendicular recording medium including a recording layer and a soft magnetic under layer. The read head element is made of a GMR (giant magneto-resistive) element or a TMR (tunneling magneto-resistive) element.

The magnetic heads 24-1 to 24-4 are connected to a head IC 26 through signal lines. The head IC 26 selects one of the magnetic heads in response to a head select signal based on a write command or a read command from a higher-level host 11 and writes or reads data. Further, the head IC 26 includes a write driver in a write system and a preamplifier in a read system.

The control board 14 includes an MPU 28. Connected to a bus 30 of the MPU 28 are a nonvolatile memory 32 which comprises a RAM and stores therein firmware including control programs and control data, and a program memory 34 which comprises a flash ROM, RAM or the like and stores therein firmware and parameters necessary for control.

Further, connected to the bus 30 of the MPU 28 are a motor drive control unit 36, a host interface control unit 38, a buffer memory 40, a nonvolatile memory 42 made of a flash memory, a buffer control unit 44 for controlling the buffer memory 40 and the nonvolatile memory 42, a format control unit 46 which functions as a hard disk controller, and a read channel 48 which functions as a write modulation unit and a read modulation unit.

The MPU 28, the volatile memory 32, the program memory 34, the host interface control unit 38, the buffer control unit 44, the format control unit 46, and the read channel 48, which are disposed on the control board 14, can be realized as a recording control circuit incorporated in one LSI.

Instead of the embodiment in which the above-described circuit components are integrated in one LSI, the recording control circuit may be constituted such that the format control unit 46, the read channel 48, etc. are incorporated in another LSI. In such a case, a control unit may be constituted by a control circuit unit including the MPU 28 and the other controllers.

The magnetic disk apparatus 10 performs a write process and a read process in accordance with commands from the host 11. An ordinary operation of the magnetic disk apparatus 10 without cache control will be described below.

When the host interface control unit 38 receives the write command and write data from the host 11, the MPU 28 decodes the write command and loads the received write data into the buffer memory 40 as required. Then, the write data is converted to a predetermined data format in the format control unit 46 and is added with an ECC (error correction code) through an ECC encoding process. After performing scrambling, RLL (run-length limited) encoding and write compensation in a write modulation system of the read channel 48, the write data is sent from a write amplifier to the head IC 26 and is written on the recording surface of the magnetic disk 22-1 from the recording head element of the selected magnetic head 24-1, for example.

At that time, a head positioning signal is provided from the MPU 28 to the motor drive control unit 36 such that the voice coil motor (VCM) 18 performs a seek of the head to the target drive instructed by the command. Thereafter, the head is put on a track and usual track control is executed.

On the other hand, when the host interface control unit 38 receives the read command from the host 11, the MPU 28 decodes the read command and the preamplifier amplifies read signals which have been read out using the read head element selected by head selection that is performed by the head IC 26. Then, the read signals are input to a read demodulation system of the read channel 48 and are subjected to automatic gain amplification, noise cut by a low-pass filter, AD conversion, and automatic equalization by an FIR (finite impulse response) filter. Further, read data is demodulated with partial response maximum likelihood (PRML) detection, for example, and is output to the format control unit 46 through RLL decoding and descrambling. After the format control unit 46 executes ECC decoding for error correction, the read data is buffered in the buffer memory 40 and is transferred to the host 11 through the host interface control unit 38.

The MPU 28 includes a cache control unit 50, a memory allocation management unit 52, and a memory allocation changing unit 54 which have respective functions realized by execution of firmware. Further, memory management information 56 is placed in the volatile memory 32, and a write cache area 58 and a read cache area 69 are allocated in the nonvolatile memory 42 which is made of a flash memory.

The cache control unit 50 loads, into the write cache area 58 of the nonvolatile memory 42, the write data that is to be recorded on the magnetic disk, when it receives the write command from the host 11.

More specifically, upon receiving the write command from the host 11, the cache control unit 50 loads the write data into the buffer memory 40 through the host interface control unit 38 and the buffer control unit 44. Then, the cache control unit 50 checks whether corresponding cache data is present in the write cache area 58. If the write cache data is present, i.e., if a cache hit is determined, the write data is written in the write cache area 58 while updating the present write cache data. If the write cache data is not present, i.e., if a mishit is determined, a new area called a “page” is prepared in the write cache area 58 and the write data is loaded into the new area.

Also, when the cache control unit 50 receives the read command from the host 11, it reads out corresponding read data from the magnetic disk and temporarily loads the read data into the read cache area 60.

More specifically, upon receiving the read command from the host 11, the cache control unit 50 checks whether corresponding read data is present in the read cache area 60 of the nonvolatile memory 42. If the corresponding read data is present, i.e., if a cache hit is determined, the read data is read out from the read cache area 60 and is loaded into the buffer memory 40. Thereafter, the read data is transferred to the host 11.

If the corresponding read data is not present in the read cache area 60, i.e., if a mishit is determined, the corresponding read data is read out from the magnetic disk and is loaded into the buffer memory 40 from the buffer control unit 44 after demodulation through the read channel 48 and the format control unit 46. Subsequent to loading, the read data is transferred to the host 11 through the host interface control unit 38.

After the transfer of the read data to the host 11, a new area called a “page” is prepared in the read cache area 60 and the read data is loaded from the buffer memory 40 into the new area in the read cache area 60 of the nonvolatile memory 42.

The memory allocation management unit 52 in the MPU 28 manages the memory management information 56 indicating respective allocated positions of the write cache area 58 and the read cache area 60 in the nonvolatile memory 42.

The memory management information 56, having been read out and placed in the volatile memory 32, is stored in a system area on one recording surface of the magnetic disk 22-1, for example. In an initialization process executed with power-on of the magnetic disk apparatus 10, the memory management information is read out from the system area of the magnetic disk 22-1 by the head 24-1, for example, and is placed as the memory management information 56 in the volatile memory 32. The memory allocation management unit 52 refers to the memory management information 56 and allocates the write cache area 58 and the read cache area 60 in the nonvolatile memory 42.

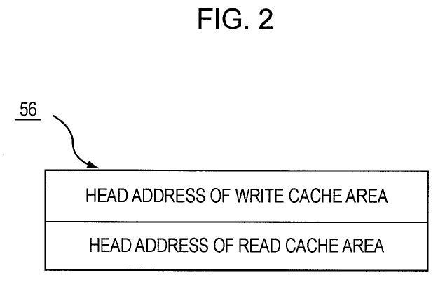

FIG. 2 is an explanatory view illustrating the memory management information 56 developed in the volatile memory 32 shown in FIG. 1. Referring to FIG. 2, the memory management information 56 includes a head address of the write cache area and a head address of the read cache area.

Once the respective head addresses of the write cache area 58 and the read cache area 60 are decided, when the write data or the read data is recorded in accordance with the write command or the read command from the host 11, a cache data loading area, called a “page” having a predetermined size of, e.g., 16 sectors, is prepared and the write data or the read data is loaded as cache data in the page.

Each time the write cache data in the write cache area 58 allocated in the nonvolatile memory 42 is all written onto the magnetic disk and the write cache area 58 is emptied, the memory allocation changing unit 54 in the MPU 28, shown in FIG. 1, updates the memory management information 56 so as to cyclically change the write cache area 58 in units of a predetermined address size that is smaller than an erase unit of the nonvolatile memory 42 made of flash memory, specifically in units of one sector size on the magnetic disk or in units of one word (1 word is, e.g., 8 bytes) thereon in the embodiment. Stated another way, the head address of the write cache area, shown in FIG. 2, registered in the memory management information, is changed by any of the above-mentioned units.

Processing executed in the memory allocation changing unit 54 with respect to the read cache area 60 is basically similar to the above-described processing. Each time the read cache data in the read cache area 60 allocated in the nonvolatile memory 42 is all invalidated and the read cache area 60 is emptied, the memory allocation changing unit 54 updates the memory management information 56 so as to cyclically change the read cache area 60 in units of a predetermined address size that is smaller than the erase unit of the nonvolatile memory 42 (flash memory), specifically in units of one sector size or one word. Stated another way, the head address of the read cache area, shown in FIG. 2, registered in the memory management information is changed by any of the above-mentioned units.

The timing at which the memory allocation changing unit 54 in the MPU 28 updates the memory management information so as to cyclically change the write cache area 58 is the timing at which the write cache data in the write cache area 58 is all written onto the magnetic disk. That timing is provided by (1) the timing at which the flash cache command is received from the host 11 and the write cache data in the write cache area 58 is written onto the magnetic disk, (2) the timing when the write cache area 58 becomes full and all the write cache data is written onto the magnetic disk, (3) all the write cache data in the write cache area 58 is forcibly written onto the magnetic disk to empty the write cache area 58 when the write cache area 58 has not been emptied at the above-mentioned timing (1) or (2) even after the lapse of a preset certain time, or (4) all the write cache data in the write cache area 58 is forcibly written onto the magnetic disk to empty the write cache area 58 when the write cache area 58 has not been emptied even after reaching the predetermined number of times of issuances of the write commands.

Thus, at each of the timings (1) to (4), the memory allocation changing unit 54 repeats a process of changing the write cache area 58 to be cyclically relocated by shifting the area head address of the write cache area 58, which is registered in the memory management information 56, in units of one sector size or one word.

The timing of updating the memory management information 56 so as to cyclically change the read cache area 60 by the memory allocation changing unit 54 is set, in this embodiment, to the timing at which it receives a read cache replacement command from the host 11.

In the case of the read cache area 60, however, because the read cache area 60 is emptied the read cache replacement command is received, the read data loaded in the read cache area 60 is not required to be written onto the magnetic disk. It is just required to invalidate all the read data loaded in the read cache area 60. The read data can be invalidated by resetting a valid flag indicating effective data in the cache management information (not shown).

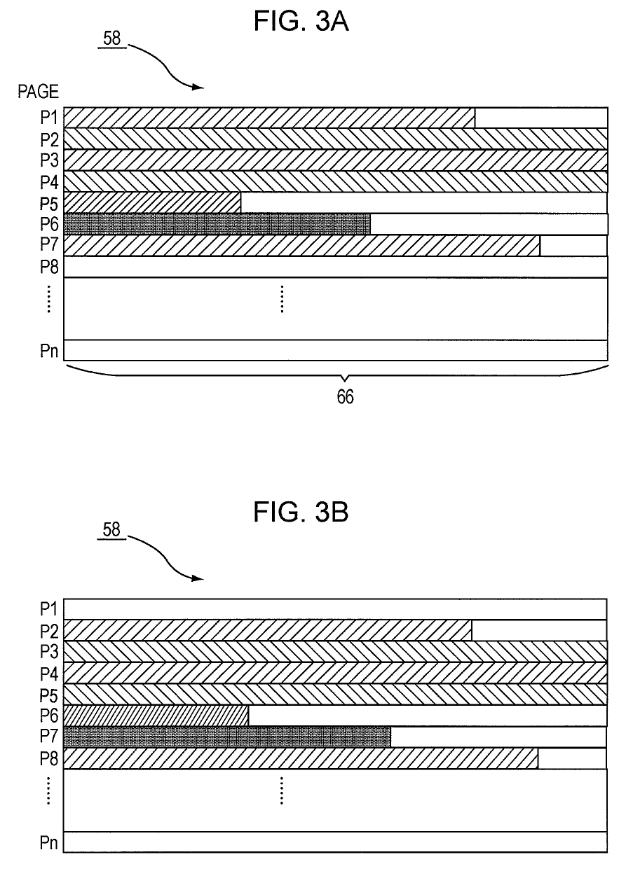

FIGS. 3A and 3B are explanatory views illustrating page division of the write cache area in the embodiment and a wear leveling process per erase unit of the nonvolatile memory, respectively.

Referring to FIG. 3A, the write cache area 58 is divided into pages P1 to Pn each of which has a page size 66 of, e.g., a 16-sector size on the magnetic disk. Assuming that one sector in the magnetic disk is 1024 bytes, 16 sectors of the page size 66 correspond to 16 KB (Kbytes).

The flash memory used in the embodiment as the nonvolatile memory 42 in which the write cache area 58 is allocated operates while the erase unit is set to, e.g., 16 KB that coincides with the page size 66. Thus, the write cache area 58 can be rewritten in units of each of the pages P1 to Pn.

For the layout of the write cache area 58 having the page size 66 that coincides with the erase unit of the flash memory, the wear leveling has been performed in the past to cyclically shift the write cache data in units of the page size 66 that coincides with the erase unit.

FIG. 3B illustrates the state where the cache data is shifted by one page size, i.e., the erase unit, in the write cache area 58 of FIG. 3A. In FIG. 3B, the write cache data present in the page P1 of FIG. 3A before the shift is moved to the next page P2, and the write cache data in the remaining pages P2 to Pn are also moved, as they are, to the succeeding pages, respectively.

Looking at each of the pages P1 to Pn, therefore, the cache data is written in the sectors nearer to the head of each page, and an empty area nearer to the end of each page remains empty even after the wear leveling. As a result, an area in each page subjected to rewrites a larger number of times and an area in the same page subjected to rewrites a smaller number of times remain as they are. Thus, an effect of the wear leveling process of averaging the number of times of rewrites in the same page is notoptimal.

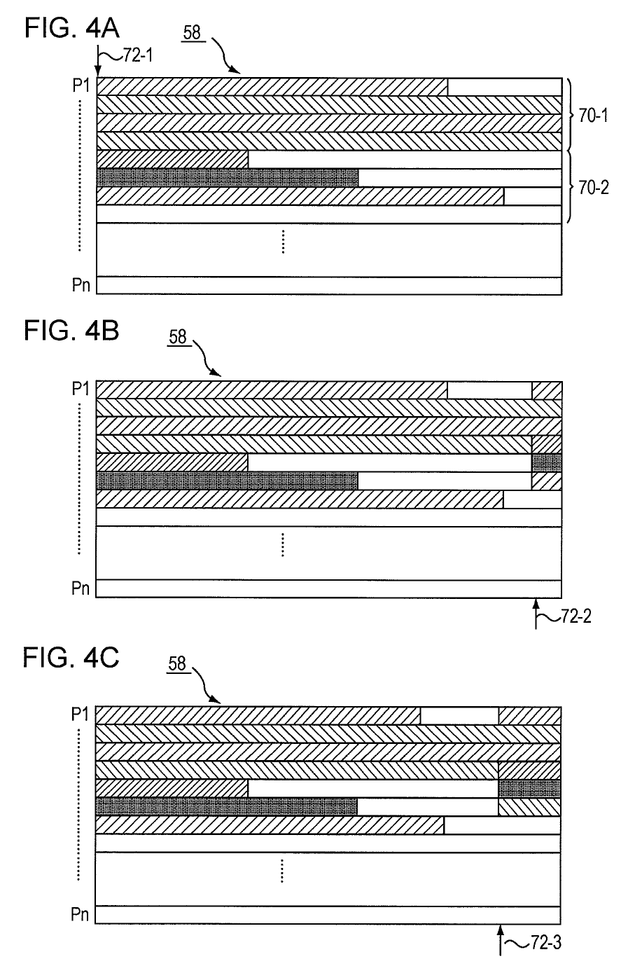

To overcome the above-described problem, in this embodiment, an effective wear leveling process of averaging the number of times of rewrites between the area in each page subjected to rewrites a larger number of times and an area in the same page subjected to rewrites a smaller number of times can be realized by cyclically changing the write cache area per unit that is smaller than the erase unit of the nonvolatile memory, as shown in FIG. 4.

FIG. 4A illustrates the write cache area 58 before the wear leveling, which is the same as that shown in FIG. 3A. Each of the pages P1 to Pn has a size of 16 KB that is equal to the erase unit of the flash memory used as the nonvolatile memory 42.

It is here supposed that for the write cache area 58 of FIG. 4A, the write cache area head address registered in the memory management information 56 is, e.g., an area head address 72-1 indicating the head of the page P1.

When the memory management information 56 is changed from the supposed state to shift the area head address 72-1 rearwards by one sector size on the magnetic disk according to the embodiment, a new area head address 72-2 is set, as shown in FIG. 4B, at a location near the end of the last page Pn based on the changed memory management information 56. If the same write data as that shown in FIG. 4A is loaded starting from the area head address 72-2, the write data is located in each of the pages in a state shifted in units of one sector size, as shown in FIG. 4B.

As shown in FIG. 4C, when the area head address is further shifted by another one sector size and changed to an area head address 72-3, the write cache data is also further shifted rearwards by one sector size in each page.

In other words, unlike the case of shifting the write cache data, which is loaded in the write cache area 58 divided into pages, by the erase unit corresponding to the page size of the flash memory as shown in FIG. 3B, the write cache data is loaded in each page while being cyclically moved in units of one sector size or one word, by shifting the cache area head address in units of sector size smaller than the erase unit, or in even smaller units of one word. Consequently, the area in each page subjected to rewrites a larger number of times and the area in the same page subjected to rewrites a smaller number of times are efficiently averaged over the number of times of rewrites, and a sufficient effect of the wear leveling is obtained. Hence, the life of the rewrite process for the nonvolatile memory 42, in which the write cache area 58 is allocated, can be prolonged to a large extent.

The process of changing the memory management information so as to cyclically shift the area head address in units of one sector size or one word, as shown in FIGS. 4A and 4B, is similarly applied to the read cache area 60 shown in FIG. 1.

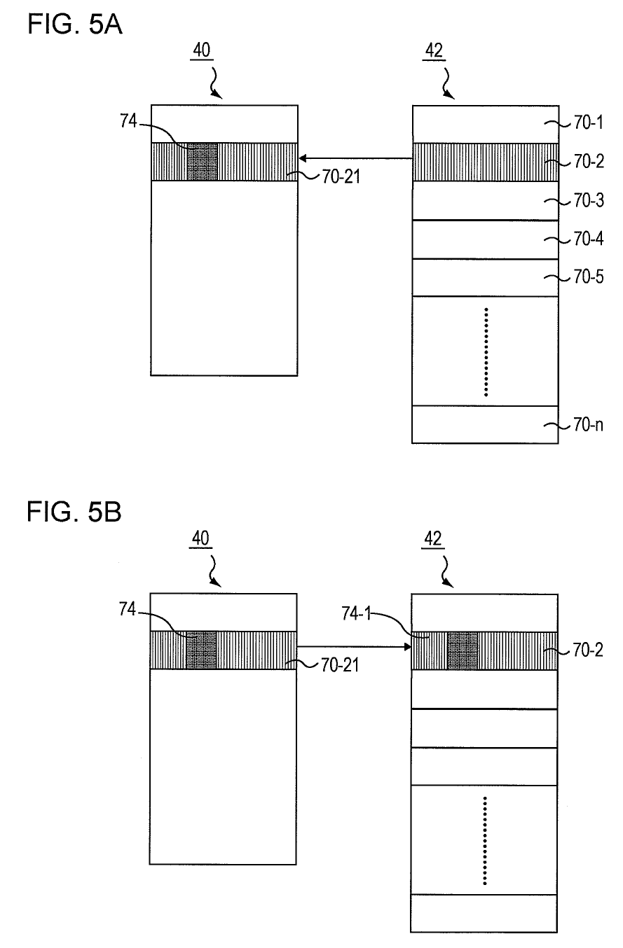

FIGS. 5A and 5B are explanatory views illustrating a data write process per erase unit in the nonvolatile memory 42 according to the embodiment.

In FIG. 5A, the nonvolatile memory 42 is divided into areas 70-1 to 70-n, each of which corresponds to the erase unit. Each of the areas 70-1 to 70-n corresponding to the erase unit has the same size, i.e., 16 KB, as the page size 66 shown in FIG. 3.

When data included in an area 70-2 is rewritten, the area 70-2 is read out from the nonvolatile memory 42 and is allocated as an area 70-21 in the buffer memory 40. In that state, for example, write data 74 received in accordance with the write command is written in the area 70-21.

When the write data 74 has been written in the buffer memory 40, the data in the area 70-21 in which the write data 74 has been written is written in the area 70-2 of the nonvolatile memory 42. As a result, the write data 74 is written as write data 74-1 in the nonvolatile memory 42.

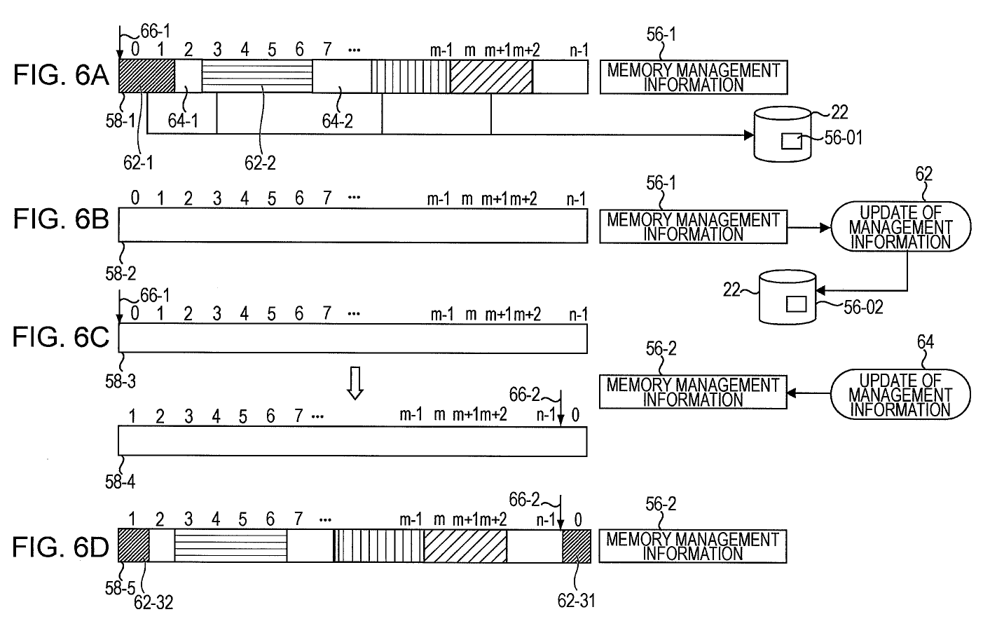

FIGS. 6A to 6D are explanatory views illustrating detailed procedures of the wear leveling process for the write cache area according to the embodiment. FIG. 6A illustrates, as one linearly extended area, the write cache area 58 shown in FIG. 3 or 4. Numerals 0 to n−1 put on the upper side of the write cache area 58 in FIG. 6A represent page numbers.

Write cache data 62-1 to 62-4 are loaded in a write cache area 58-1, and white (blank) portions represent empty areas 64-1 to 64-3

In such an allocation, the memory management information 56 includes, for setting of synchronization, an area head address 66-1 that indicates a head position of the write cache area 58-1.

In the state of the write cache area 58-1 in which the write cache data is loaded as shown in FIG. 6A, when the flash command is received from the host, for example, the cache data 62-1 to 62-4 are all written onto the magnetic disk 22 and the write cache area is emptied as indicated by 58-2 in FIG. 6B.

When the write cache area 58-2 is emptied as described above, the memory allocation changing unit 54 in the MPU 28, shown in FIG. 1, executes a management information updating process 62 of shifting the area head address 66-1 of memory management information 56-1 rearwards by one sector size, for example.

After the update of the memory management information 56-1, the updated information is written as memory management information 56-2 onto the magnetic disk 22 because it is important information indicating the memory configuration. Further, after success of the write onto the magnetic disk 22, the memory management information 56-1 developed so far in the nonvolatile memory is rewritten to new memory management information 56-2 updated through a management information updating process 64, as shown in FIG. 6C.

With the rewrite to the memory management information 56-2, the area head address 66-1 having been set so far to the head of the page 0 as indicated by a write cache area 58-3 in FIG. 6C, is changed to an area head address 66-2 which is shifted rearwards from 66-1 by one sector size, as indicated by a write cache area 58-4. Then, the page division is performed starting from the area head address 66-2 as indicated by the page numbers 0 to n−1.

Stated another way, the state of the write cache area is changed from the write cache area 58-3 to the write cache area 58-4 in which the allocation of the write cache data is shifted rearwards in units of one sector size.

Then, as shown in FIG. 6D, if the same write cache data 62-1 to 62-4 as those in FIG. 6A are loaded into a write cache area 58-5 relocated in accordance with the updated memory management information 56-2, the write cache data 62-1 on the forward side including the head page, i.e., the page 0, in FIG. 6A is divided into write cache data 62-31 on the rearward side and write cache data 62-32 on the forward side after the update of the memory management information, as shown in FIG. 6D. Also, between those write cache data 62-31 and 62-32, the write cache data 62-2 to 62-4 are loaded at respective locations each shifted rearwards by one sector size.

Thus, in this embodiment of the present invention, each time all the write cache data in the write cache area is written onto the magnetic disk and the write cache area is emptied, the memory management information is updated so as to cyclically shift the area head address rearwards in units of, e.g., one sector size. Therefore, if all the write cache data to be loaded in the write cache area are not changed, they are cyclically moved in the write cache area while successively shifting in units of one sector size. By so repeating the cyclic shift of the write cache data in units of one sector size, the number of times of writes is averaged between an area subjected to a larger number of writes and an area subjected to a smaller number of writes even when empty areas are generated in the write cache area at random. As a result, the life of the flash memory used as the nonvolatile memory 42 can be prolonged.

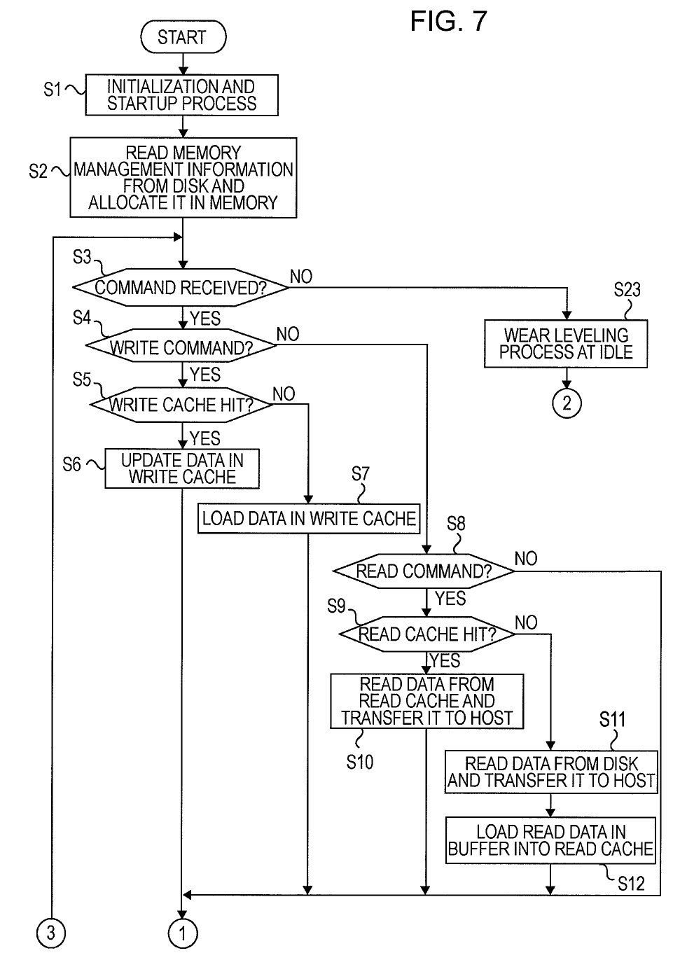

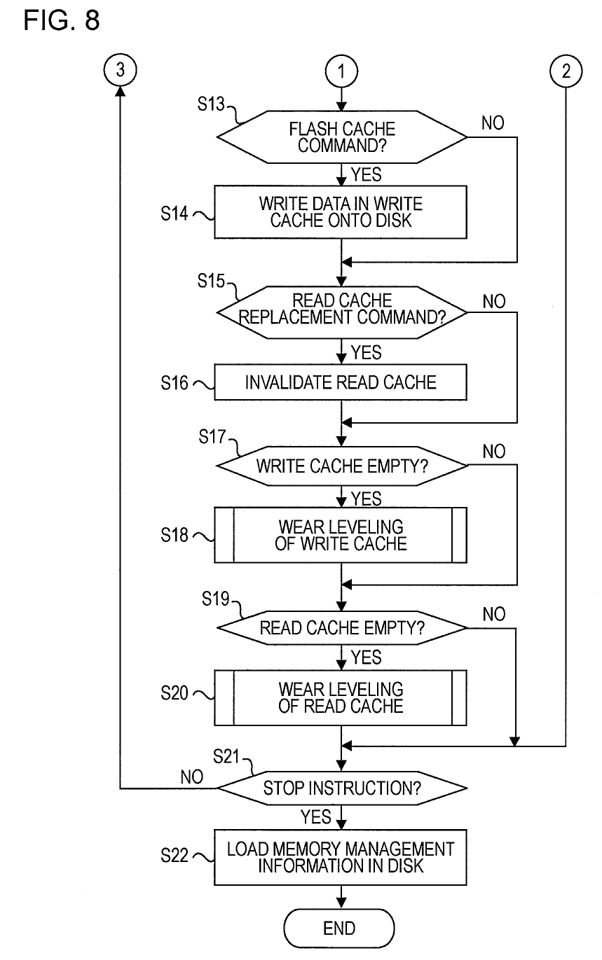

FIGS. 7 and 8 are flowcharts illustrating a control process, including the wear leveling, of the hybrid magnetic apparatus according to the embodiment. Referring to FIG. 7, when power supplied to the magnetic disk apparatus 10 is turned on with startup of the host 11, an initialization and startup process is executed in step S1.

The initialization and startup process is executed by the MPU 28 reading out firmware, which functions as an OS with execution of a boot program stored in, e.g., a flash ROM of the program memory 34, from the system area on the recording surface of, e.g., one of the magnetic disks 22-1 and 22-2 and placing the firmware in the volatile memory 32.

Then, in step S2, memory management information stored in the system area of the magnetic disk, for example, is read out and placed, as the memory management information 56, in the volatile memory 32 as shown in FIG. 1.

Then, if reception of the command from the host 11 is determined in step S3, it is determined in step S4 whether the received command is a write command. If the received command is the write command, write data transferred from the host 11 is temporarily held in the buffer memory 40 through the host interface control unit 38 and the buffer control unit 44.

In such a state, the cache control unit 50 checks for a write cache hit, i.e., whether corresponding data is present in the write cache area 58 of the nonvolatile memory 42. If the write cache hit is found, the data in the write cache area 58 is updated in step S6, and a normal end of the write command is sent to the host 11 without writing the write cache data onto the magnetic disk.

If a write cache mishit is found in step S5, a new page is prepared in the write cache area 58 and the write data is loaded in the new page in step S7. Also in this case, a normal end of the write command is sent to the host 11 without writing the write data onto the magnetic disk.

On the other hand, if a read command is found in step S8, the cache control unit 50 checks the read cache area 60 of the nonvolatile memory 42 and executes a read cache hit, i.e., determines whether corresponding read data is present in the read cache area 60, in step S9.

If the read cache hit is found, the corresponding data is read from the read cache area 60 into the buffer memory 40 and the read data is transferred to the host 11 in step S10.

If a read cache mishit is found in step S9, data is read out from the magnetic disk through the head IC 26, the read channel 48, and the format control unit 46, following which the read data is loaded into the buffer memory 40 by the buffer control unit 44 and is transferred to the host 11 through the host interface control unit 38 in step S11. Subsequently, the read data loaded in the buffer memory 40 is loaded into the read cache area 60 in step S12.

Next, the cache control unit 50 checks in step S13 of FIG. 8 whether a flash cache command has been received from the host 11. If so, the processing advances to step S14 in which all the cache data in the write cache area 58 of the nonvolatile memory 42 is written onto the magnetic disk and the write cache area 58 is emptied.

In step S15, the cache control unit 50 checks whether a read cache replacement command has been received from the host 11. If so, the processing advances to step S16 in which all the read data in the read cache area 60 of the nonvolatile memory 42 is invalidated and the read cache area 60 is emptied.

Then, the processing advances to step S17 in which it is determined whether the write cache area 58 is empty. If the write cache area 58 is empty, the processing advances to step S18 in which wear leveling of the write cache area 58 (i.e., write cache wear leveling) is executed.

If it is determined in step S19 that the read cache area 60 is empty, the processing advances to step S20 in which wear leveling of the read cache area 60 (i.e., read cache wear leveling) is executed.

In step S21, the cache control unit 50 checks for issuance of a stop instruction. The processing subsequent to step S13 is repeated until issuance of the stop instruction. If the stop instruction is received, the memory management information 56 in the volatile memory 32 is written onto the magnetic disk in step S22, following which the processing is brought to an end.

On the other hand, if an idle state where no commands are received from the host 11 is determined in step S3 of FIG. 7, wear leveling at idle is executed in step S23.

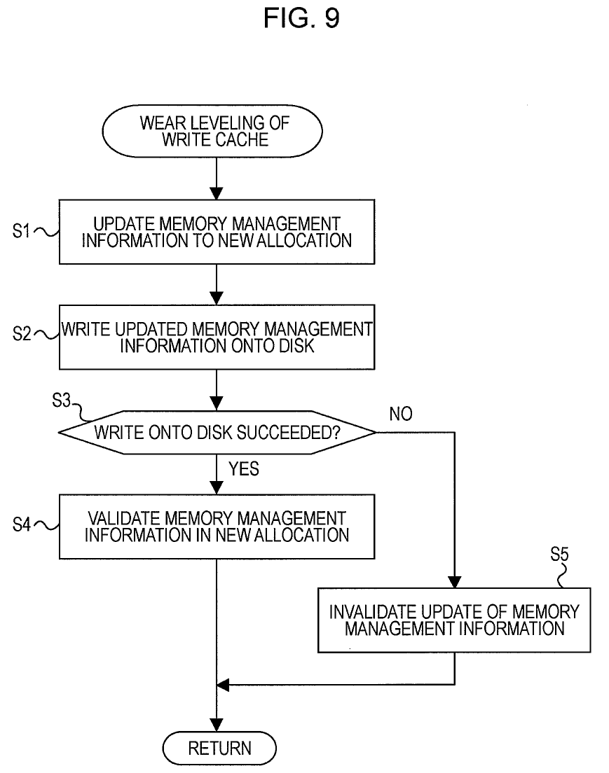

FIG. 9 is a flowchart illustrating details of the write cache wear leveling in step S18 of FIG. 8. In the write cache wear leveling shown in FIG. 9, the write cache area head address, shown in FIG. 2, contained in the memory management information 56 in the volatile memory 32 is reduced in step S1 by, e.g., one sector size on the magnetic disk, thus updating the write cache area 58 in the nonvolatile memory 42 of the magnetic disk apparatus to a newly allocated layout in which locations are shifted by one sector size from those in the preceding state.

Then, in step S2, the updated memory management information 56 is written onto the system area of the magnetic disk. More specifically, since the memory management information is important information indicating the memory configuration in the nonvolatile memory 42, the memory management information 56 updated in the volatile memory 32 is temporarily written onto the magnetic disk for storage therein so that the updated memory management information 56 in the volatile memory 32 will not be lost due to, e.g., power cutoff of the magnetic disk apparatus, which could be caused by a failure, for example.

If it is determined in step S3 that the write process of the updated memory management information onto the magnetic disk has succeeded, the processing advances to step S4, in which the updated memory management information representing the new allocation is validated and write of the write data in accordance with the write command is started on the write cache area 58, which is empty at that time, by using the updated memory management information.

On the other hand, if it is determined in step S3 that the write process of the updated memory management information on the magnetic disk has not succeeded, the update of the memory management information is invalidated in step S5 and the allocation of the write cache area 58 corresponding to the memory management information before the update is maintained.

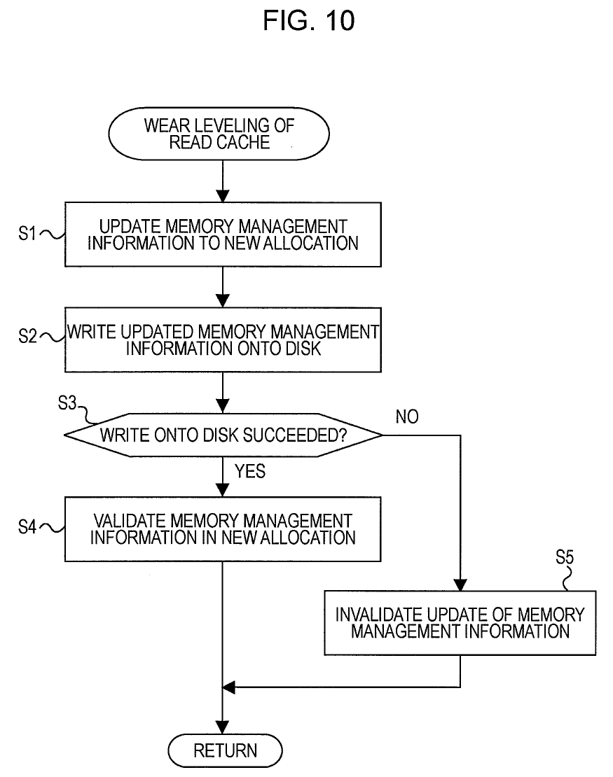

FIG. 10 is a flowchart illustrating details of the read cache wear leveling in step S20 of FIG. 8. In the read cache wear leveling shown in FIG. 10, if the read cache area 60 is empty, the read cache area head address, shown in FIG. 2, contained in the memory management information 56 in the volatile memory 32, is reduced in step S1 by, e.g., one sector size on the magnetic disk, thus updating the read cache area 60 in the nonvolatile memory 42 to a newly allocated layout.

Then, in step S2, the updated memory management information 56 is written from the volatile memory 32 onto the system area of the magnetic disk for storage therein. If it is determined in step S3 that the write process of the updated memory management information onto the magnetic disk has succeeded, the updated memory management information representing the new allocation is validated in step S4.

Accordingly, the read cache area 60 in the nonvolatile memory 42 is relocated such that the area head position is shifted by one sector size in a direction to reduce its address with respect to the address before the wear leveling. Then, the read data is loaded into the relocated read cache area in accordance with the read command from the host.

On the other hand, if it is determined in step S3 that the write process of the updated memory management information onto the magnetic disk has not succeeded, the update of the memory management information is invalidated in step S5, and the memory management information before the wear leveling is maintained.

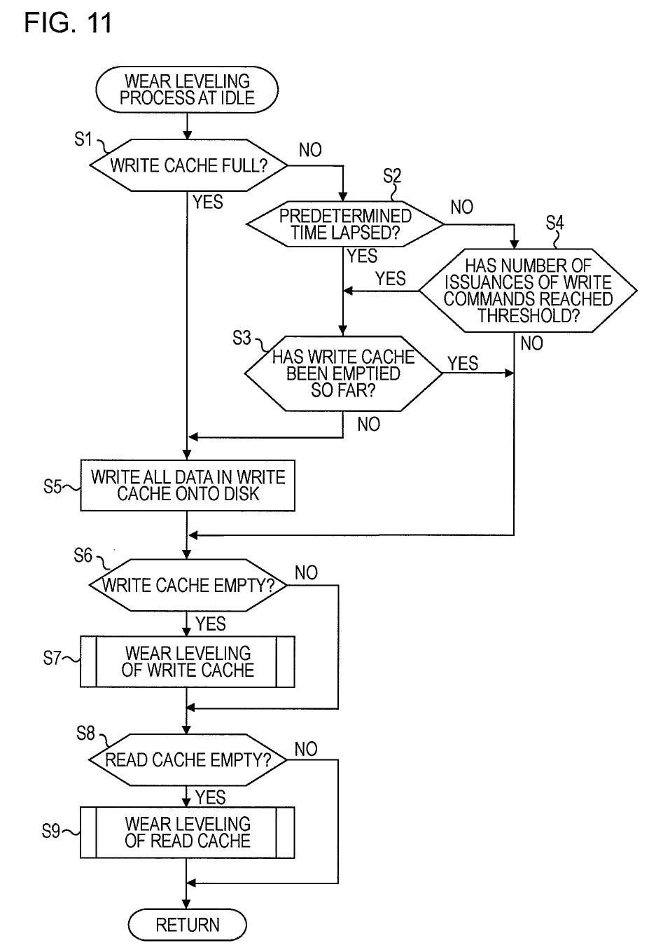

FIG. 11 is a flowchart illustrating details of the wear leveling process at idle in step S23 of FIG. 7. In the wear leveling process at idle shown in FIG. 11, it is determined in step S1 whether the write cache area 58 in the nonvolatile memory 42 is full. If the write cache area 58 is full, the processing advances to step S5 in which all the write cache data is written onto the magnetic disk and the write cache area 58 is emptied for the wear leveling.

If it is determined in step S1 that the write cache area 58 is not full, the processing advances to step S2 to check whether a predetermined time has lapsed from the time when the write cache area was emptied and the wear leveling was last executed. If the predetermined time has lapsed, the processing advances to step S3 to check whether the write cache area has been emptied at least once. If the write cache area has not been emptied even once, all the write cache data in the write cache area 58 is forcibly written onto the magnetic disk and the write cache area 58 is emptied in step S5.

If it is determined in step S2 that the predetermined time has not yet lapsed, the processing advances to step S4, in which the number of times of issuances of the write commands generated during a period from the time when the write cache area was emptied and the wear leveling was executed the last time, up to the present time is obtained to determine whether the number of times of issuances of the write commands has reached a threshold.

If the number of write commands has reached the threshold, the processing advances to step S3 to determine whether the write cache area has been emptied at least once. If the write cache area has not been emptied even once, all the write cache data in the write cache area 58 is forcibly written onto the magnetic disk and the write cache area 58 is emptied in step S5.

Then, it is checked in step S6 whether the write cache area 58 is empty. If the write cache area 58 is empty, the write cache wear leveling is executed in step S7. Details of the write cache wear leveling in step S7 are the same as those illustrated in the flowchart of FIG. 9.

Further, if it is determined in step S8 that the read cache area 60 is empty, the processing advances to step S9, where the read cache wear leveling is executed in the same manner as that shown in FIG. 10.

Thus, according to this embodiment, the wear leveling for averaging the number of writes between different locations in each of the write cache area 58 and the read cache area 60, which are allocated in the nonvolatile memory 42 of the magnetic disk apparatus, is executed when the write cache area 58 or the read cache area 60 is emptied in accordance with the flash cache command or the read cache replacement command, in step S13 or S15 of FIG. 8, from the host 11. In addition, as described in the wear leveling at idle with reference to FIG. 11, the wear leveling can also be executed by the magnetic disk apparatus 10 itself, without depending on the commands from the host 11. More specifically, the wear leveling of the write cache area 58, i.e., the write cache wear leveling, can be executed by forcibly writing all the write cache data in the write cache area 58 onto the magnetic disk and emptying the write cache area 58, for example, when the write cache area 58 has become full, when the write cache area has not been emptied even once although the predetermined time has lapsed from the previous wear leveling, or when the write cache area has not been emptied even once although the number of time of issuances of the write commands has reached the threshold.

Further, the present invention provides a program that is executed by the MPU 28 included in the magnetic disk apparatus 10 of FIG. 1. The contents of the program correspond to the flowcharts shown in FIGS. 7 to 11.

In the above-described embodiment, when the flash cache command is received from the host, all the write cache data in the write cache area 58 is written onto the magnetic disk and the write cache area 58 is emptied. Alternatively, the write cache area 58 may be divided into plural areas such that the write cache wear leveling is executed for each of the divided write cache areas by successively writing the write cache data in each of the divided write cache areas onto the magnetic disk and emptying each of the divided write cache areas whenever the flash cache command is received.

That point is similarly applied to the read cache area 60. In other words, the read cache area 60 may be divided into plural areas such that the read cache wear leveling is executed for each of the divided read cache areas by successively invalidating the read cache data in each of the divided read cache areas and emptying each of the divided read cache areas whenever the read cache replacement command is received from the host.

Executing the wear leveling by dividing each of the write cache area 58 and the read cache area 60 into plural areas and successively emptying each of the divided cache areas is advantageous in that the cache data can be kept remained in divided cache areas other than the target area even when the wear leveling is executed. Thus, since part of the cache data remains, it is possible to minimize a reduction of input/output performance with respect to the host 11, which is caused by using the cache, as compared with the case of removing all the cache data to empty the cache area.

Further, the foregoing embodiment is described in connection with the case where the page size 66 is equal to the erase unit, as shown in FIG. 3A. However, the erase unit of the flash memory is not limited to the page size, and a flash memory having an appropriate erase size, e.g., 32 KB or 64 KB, which is an integer times the page size, can also be used as required.

In addition, even when the erasing process is no longer required in rewrite of the nonvolatile memory, the wear leveling technique according to the present invention is effective so long as there is a limitation in the number of times of rewrites. The reason is that such a case also accompanies the necessity of overcoming unbalance in frequency of use, which is caused by managing a cache in units of page.

According to the embodiment of the present invention, since the memory management information representing the allocation of the cache area in the nonvolatile memory is held on the magnetic disk medium instead of the nonvolatile memory, the cache area in the nonvolatile memory can be relocated so as to cyclically shift the entire layout thereof in units of minimum size, e.g., in units of one sector size or one word, which is smaller than the erase unit of the nonvolatile memory, when the cache area in the nonvolatile memory is emptied. As a result, even when each of the pages divided in the cache area includes a frequently used portion and a not so frequently used portion, the number of uses can be efficiently averaged between those portions, and the number of rewrites can be increased even when a nonvolatile memory, e.g., a flash memory, having a limitation in the number of times of rewrites is used.

Further, since the memory management information representing the location of the cache area in the nonvolatile memory is held on the magnetic disk medium, a difficulty in the wear leveling which is caused by the necessity of taking into account the number of rewrites of the memory management information the memory management information is placed in the nonvolatile memory can be eliminated. Hence, a simple and efficient wear leveling technique can be realized.

Additionally, it is to be understood that the present invention includes appropriate variations without departing from the object and the advantages thereof, and the present invention is not restricted by numerical values mentioned in the embodiment described above.

What is claimed is:

1. A recording apparatus comprising:
a magnetic disk medium for recording and reading data by a magnetic head;
a nonvolatile memory in which a write cache area is allocated;
a cache control unit for temporarily loading write data, which is recorded on the magnetic disk medium, into the write cache area in accordance with a write request from a higher-level apparatus;
a memory allocation management unit for storing memory management information in the magnetic disk medium for management thereof, the memory management information representing an allocated position of the write cache area in the nonvolatile memory; and
a memory allocation changing unit for changing the memory management information to cyclically shift the write cache area in units of a predetermined address size that is smaller than an erase unit of the nonvolatile memory, whenever the write cache area is emptied.

2. The recording apparatus according to claim 1, wherein the memory allocation management unit registers an area head address of the write cache area in the memory management information for management thereof, and
the memory allocation changing unit shifts the area head address registered in the memory management information in units of the predetermined address size.

3. The recording apparatus according to claim 1, wherein when power is turned on, the memory allocation management unit reads out the memory management information from the magnetic disk medium and places the read-out memory management information in a volatile memory.

4. The recording apparatus according to claim 3, wherein when the memory management information is changed in the volatile memory, the memory allocation management unit writes the changed memory management information onto the magnetic disk medium and executes the management by using the changed memory management information on condition that the write of the changed memory management information onto the magnetic disk medium has succeeded.

5. The recording apparatus according to claim 1, wherein the memory allocation changing unit changes the memory management information to cyclically shift the write cache area in units of one sector size on the magnetic disk medium.

6. The recording apparatus according to claim 1, wherein the memory allocation changing unit changes the memory management information to cyclically shift the write cache area in units of one word on the magnetic disk medium.

7. The recording apparatus according to claim 1, wherein the cache control unit writes all the write cache data in the write cache area onto the magnetic disk medium to empty the write cache area when a predetermined command is received from the higher-level apparatus, when the write cache area becomes full of the write cache data, or when a vacant capacity of the write cache area is reduced to a predetermined value or less.

8. The recording apparatus according to claim 1, wherein the memory allocation changing unit forcibly writes all the write cache data in the write cache area onto the magnetic disk medium to empty the write cache area when the write cache data in the write cache area allocated in the nonvolatile memory is not moved after a predetermined time has lapsed or after the number of write requests has reached a predetermined value.

9. A recording apparatus comprising:
a magnetic disk medium for recording and reading data by a magnetic head;
a nonvolatile memory in which a read cache area is allocated;
a cache control unit for temporarily loading read data, which is read from the magnetic disk medium, into the read cache area in accordance with a read request from a higher-level apparatus;
a memory allocation management unit for storing memory management information in the magnetic disk medium for management thereof, the memory management information representing an allocated position of the read cache area in the nonvolatile memory; and
a memory allocation changing unit for changing the memory management information to cyclically shift the read cache area in units of a predetermined address size that is smaller than an erase unit of the nonvolatile memory, whenever a part or the whole of read cache data in the read cache area allocated in the nonvolatile memory is invalidated and the part or the whole of the read cache area is emptied.

10. The recording apparatus according to claim 9, wherein the memory allocation management unit registers an area head address of the read cache area in the memory management information for management thereof, and
the memory allocation changing unit shifts the area head address registered in the memory management information in units of the predetermined address size.

11. The recording apparatus according to claim 9, wherein when power is turned on, the memory allocation management unit reads out the memory management information from the magnetic disk medium and places the read-out memory management information in a volatile memory.

12. The recording apparatus according to claim 11, wherein when the memory management information is changed in the volatile memory, the memory allocation management unit writes the changed memory management information onto the magnetic disk medium and executes the management by using the changed memory management information on condition that the write of the changed memory management information onto the magnetic disk medium has succeeded.

13. The recording apparatus according to claim 9, wherein the memory allocation changing unit changes the memory management information to cyclically shift the read cache area in units of one sector size on the magnetic disk medium.

14. The recording apparatus according to claim 9, wherein the memory allocation changing unit changes the memory management information to cyclically shift the read cache area in units of one word on the magnetic disk medium.

15. The recording apparatus according to claim 9, wherein the cache control unit invalidates all the read cache data in the read cache area to empty the read cache area when a predetermined command is received from the higher-level apparatus.

16. A control circuit for a recording apparatus comprising a magnetic disk medium for recording and reading data by a magnetic head; and
a nonvolatile memory in which a write cache area and a read cache area are allocated, the control circuit comprising:
a cache control unit for temporarily loading write data, which is recorded on the magnetic disk medium, into the write cache area in accordance with a write request from a higher-level apparatus, and for temporarily loading read data, which is read from the magnetic disk medium, into the read cache area in accordance with a read request from the higher-level apparatus;
a memory allocation management unit for storing memory management information on the magnetic disk medium for management thereof, the memory management information representing respective allocated positions of the read cache area and the write cache area in the nonvolatile memory;
a first memory allocation changing unit for changing the memory management information to cyclically shift the write cache area in units of a predetermined address size that is smaller than an erase unit of the nonvolatile memory, whenever write cache data in the write cache area allocated in the nonvolatile memory is all written onto the magnetic disk medium and the write cache area is emptied; and
a second memory allocation changing unit for changing the memory management information to cyclically shift the read cache area in units of a predetermined address size that is smaller than an erase unit of the nonvolatile memory, whenever read cache data in the read cache area allocated in the nonvolatile memory is all invalidated and the read cache area is emptied.

17. The recording apparatus according to claim 16, wherein the memory allocation management unit registers respective area head addresses of the write cache area and the write cache area in the memory management information for management thereof, and
the memory allocation changing unit shifts the area head addresses registered in the memory management information in units of the predetermined address size.

18. The recording apparatus according to claim 16, wherein when power is turned on, the memory allocation management unit reads out the memory management information from the magnetic disk medium and places the read-out memory management information in a volatile memory.

19. The recording apparatus according to claim 18, wherein when the memory management information is changed in the volatile memory, the memory allocation management unit writes the changed memory management information onto the magnetic disk medium and executes the management by using the changed memory management information on condition that the write of the changed memory management information onto the magnetic disk medium has succeeded.

20. The recording apparatus according to claim 16, wherein each of the first memory allocation changing unit and the second memory allocation changing unit changes the memory management information to cyclically shift the write cache area or the read cache area in units of one sector size or one word on the magnetic disk medium.
